(19) United States
(12) Patent Application Publication
(10) Pub. No.: US 2018/0108336 A1
(43) Pub. Date: Apr. 19, 2018

(54) Solderless Electronic System for Electrical String Instrument

(71) Applicant: Edward Charles Heisler, Scottsdale, AZ (US)

(72) Inventor: Edward Charles Heisler, Scottsdale, AZ (US)

(21) Appl. No.: 15/782,283

(22) Filed: Oct. 12, 2017

Related U.S. Application Data
(60) Provisional application No. 62/408,612, filed on Oct. 14, 2016.

(51) Int. Cl. G10H 3/18; G10D 1/08

(52) U.S. Cl. CPC G10H 3/186; G10H 2220/155; G10D 1/085

(57) ABSTRACT

A system for the upgrade of an electric stringed instrument for enhancing the musical or artistic performance of a user is provided. The system includes a varying number of potentiometers to be used to control the volume and tone of the instrument in combination with other electrical components such as switches and connecting output jack to be part of the system. Each of the potentiometers have the capably of multiple resistance values. The installer of the system will have the ability to choose the value of their volume and tone potentiometers from one of the multiple values obtained from each of the potentiometers to obtain the best tone option for their instrument. In addition, the system provides the user the option to operate the instrument's multiple magnetic pickups at different resistance values with the same multiple resistance potentiometer. All components are to be solderless connected together with wires to terminals. Terminals may be color coded for identification purposes.

### BACKGROUND

The embodiments herein relate generally to electric stringed instruments. More specifically, embodiments of the invention relate to an electric and bass guitars for enhancing a user's musical performance.

Electric stringed instruments such as the electric guitar, bass guitar, and acoustic electric guitar, but not limited to, comprise a variety of components including a body, neck, strings, bridge, one or more pickups and the internal electronics needed for the guitar to produce a signal to be amplified. There exist basic standardized electronics in every guitar. However, these current designs for guitar electronics are limited because they adhere to a paradigm of industry standards based on vintage guitar designs. These designs are limited and were specific for the instruments of the time. Guitars today are more advance and require more options for its electronics. Having an electronic system for guitars with multiple resistance value potentiometers allows the musician to wire their instrument to its tonal needs and provide the musician with the best sounding instrument. Further, by having the system completely solderless allows for easier installation and changes.

As such, there is a need in the industry for an electronics system for the electric guitar, bass guitar, and acoustic electric guitar, but not limited to, with the options that overcomes the limitations of the prior art. In particular, there is a need for a solderless system for guitar electronics which enhances the musical and/or artistic performance of the user.

### SUMMARY

A system for the upgrade of an electric stringed instrument for enhancing the musical or artistic performance of a user is provided. The system includes a varying number of potentiometers to be used to control the volume and tone of the instrument in combination with other electrical components such as switches and connecting input jacks to be part of the system. Each of the potentiometers have the capably of multiple resistance values. The installer of the system will have the ability to choose the value of their volume and tone potentiometers from one of the multiple values obtained from each of the potentiometers to obtain the best tone option for their instrument. In addition, the system provides the user the option to operate the instrument's multiple magnetic pickups at different resistance values with the same multiple resistance potentiometer. All components are solderless to be connected together with wires to terminals. Terminals may be color coded for identification purposes.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of the system's dual value potentiometer; and

FIG. 2 depicts a top view of the system's dual value potentiometer.

FIG. 3 depicts a prior art wiring of a typical guitar's electronics; and

FIG. 4 depicts the upgraded wiring with the system of claim on a typical guitar.

### DETAILED DESCRIPTION OF CERTAIN EMBODIMENTS

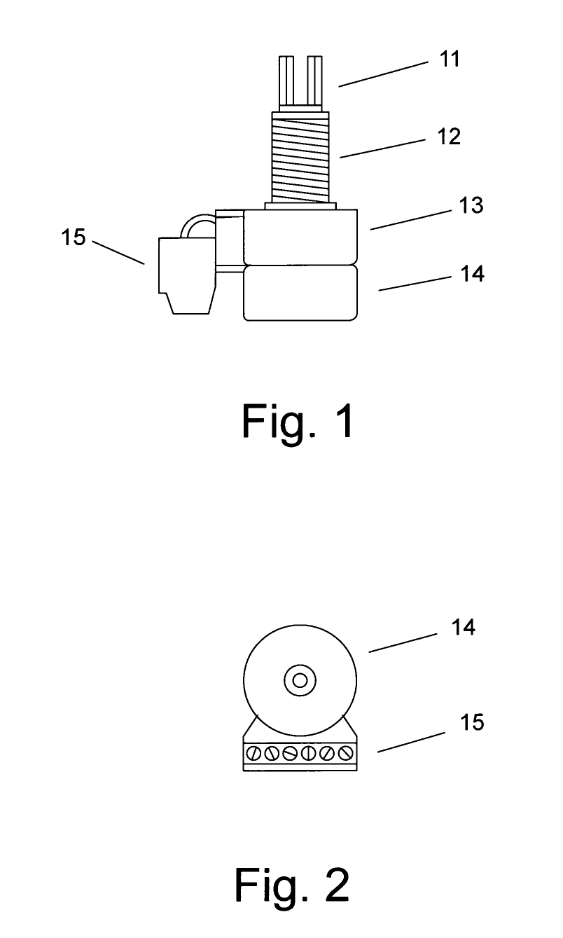

As depicted in FIGS. 1-2, the dual value potentiometer comprises the shaft 11, bushing 12, 500k side of potentiometer 13, 250k side of potentiometer 14, and terminal 15. Bushing 12 has a diameter of eight millimeters and a length of twelve millimeters. 500k side of potentiometer 13 can be bridged together with the 250k side of potentiometer 14 utilizing terminal 15. Terminal 15 allows for wires to be connected to the dual value potentiometer without the need of solder. These may be screw terminals, spring-cage, or similar, but not limited to.

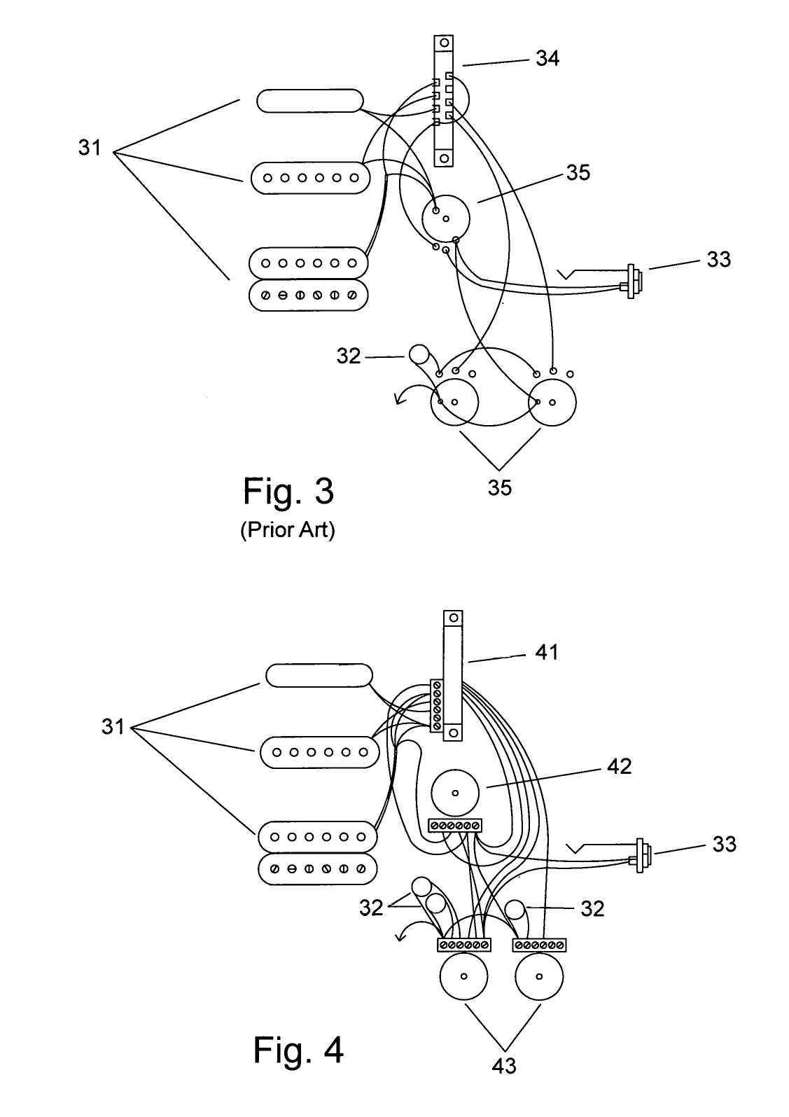

As depicted in FIG. 3, guitar pickups 31, tone capacitor 32, output jack 33, standard selector switch 34, standard single value potentiometers 35. FIG. 3 depicts a prior art example wiring of a typical guitar, but not limited to. It shows the limitations with all the pickups 31 having to be soldered to the switch 34 and potentiometers 35. The potentiometers 35 have only a single value and with no options. The tone capacitor 32 is utilized for both tone potentiometers 35 offering minimal options.

As depicted in FIG. 4, guitar pickups 31, tone capacitor 32, output jack 33, terminal selector switch 41, terminal volume potentiometer 42, terminal tone potentiometers 43. FIG. 4 depicts an example wiring of a typical guitar, but not limited to. It shows just one of the many combinations of wiring the pickups 31 to the terminal selector switch 41, terminal volume potentiometer 42, and terminal tone potentiometers 43. Connections to all points to the terminal switch 41, terminal volume potentiometer 42, and terminal tone potentiometers 43 are to terminal and require no solder for installation. The terminal volume potentiometer 42, and terminal tone potentiometers 43 are dual value and can be connected for a third value. The terminal volume potentiometer 42, and terminal tone potentiometers 43 have color coded terminals for easy identification. FIG. 4 depicts one of the pickups 31 attached to the 500k side of the terminal volume potentiometer 42, and terminal tone potentiometer 43 and the other pickups 31 attached to the 250k side of the terminal volume potentiometer 42, and terminal tone potentiometers 43 through the terminal selector switch 41. The tone capacitors 32 has at least one for each of the pickups 31 on the terminal tone potentiometers 43 providing multiple options.

It shall be appreciated that the components of the system may be manufactured and assembled by hand or using any known machining techniques in the field. It shall be appreciated that the combination of the components will vary in number and assembly depending on configuration.

In operation, the user will generally use the system for the upgrade of an electric stringed instrument for enhancing the musical or artistic performance of a user as an upgrade to a guitar's original electrical components, but not limited to. A manufacture may also utilize the system as a standard option on their instruments. The system is designed to upgrade a user's electric guitar without the use of a solder iron and with minimal skills. The user will have the ability to choose the value of the systems terminal volume potentiometer 42, and terminal tone potentiometer 43 from either 250k, 500k, 750k, but not limited to. In addition, the user will be able to operate multiple pickups 31 with one terminal volume potentiometer 42, or one terminal tone potentiometer 43 at 250k and another at 500k by utilizing the 500k side of the potentiometer 13 and the 250k side of potentiometer 14 of the same terminal volume potentiometer 42, or one terminal tone potentiometer 43. The user will also have the ability to quickly make changes via the terminals attached to the terminal selector switch 41, terminal volume potentiometer 42, terminal tone potentiometers 43, but not limited to. Tone capacitors 32 can also easily be changed out for other types of capacitors via the terminals attached to the terminal selector switch 41, terminal volume potentiometer 42, terminal tone potentiometers 43, but not limited to. All of which offer the user the ability to quickly and easily find the tone they are looking to achieve without the need of a solder iron.

It shall be appreciated that the components of the system described in several embodiments herein may comprise any alternate known materials in the field and be of any color, size, resistance values, and/or dimensions. While the embodiments described herein relate to a wiring system, it shall be appreciated that embodiments of the invention may also apply to any other electric stringed instrument such as a guitar, bass guitar, or the like.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for the upgrade of an electric stringed instrument for enhancing the musical or artistic performance of a user is provided. The system comprising of a varying number of potentiometers to be used to control the volume and tone of the instrument in combination with other electrical components such as switches and connecting output jack to be part of the system. Each of the potentiometers have the capably of multiple resistance values. The installer of the system will have the ability to choose the value of their volume and tone potentiometers from one of the multiple values obtained from each of the potentiometers to obtain the best tone option for their instrument. In addition, the system provides the user the option to operate the instrument's multiple magnetic pickups at different resistance values with the same multiple resistance potentiometer. All components are to be solderless connected together with wires to terminals. Terminals may be color coded for identification purposes. Each of the potentiometers are designed with a mounting bushing of a specific size and shape for universal installation into a variety of instruments.

2. The system of claim 1 for the upgrade of an electrical enhanced string instrument, said system comprising:
a. multiple components each having terminals for the attachment of wires to connect each component;
b. at least a first volume potentiometer offering three resistance values along with terminals that may, or not, be color coded to connect to other components and signal from switch or pickup;
c. at least a second volume potentiometer offering three resistance values along with terminals that may, or not, be color coded to connect to other components and signal from switch or pickup;
d. at least a third volume potentiometer offering three resistance values along with terminals that may, or not, be color coded to connect to other components and signal from switch or pickup;
e. at least a first tone potentiometer offering three resistance values along with terminals that may, or not, be color coded to connect to other components and the attachment of tone capacitor;
f. at least a second tone potentiometer offering three resistance values along with terminals that may, or not, be color coded to connect to other components and the attachment of tone capacitor;
g. at least a first switch for selecting at least one of the said volume potentiometers for the routing of signal from said volume potentiometers or to said volume potentiometers;
h. at least a second switch for selecting at least one of the said volume potentiometers for the routing of signal from said volume potentiometers or to said volume potentiometers;
i. at least a first switch for altering signal from pickup or from said volume potentiometers;
j. at least a second switch for altering signal from pickup or from said volume potentiometers;
k. and at least one pickup terminal on said components for link to other said components

3. The system of claim 1 whereby said solderless attachment is by means of screw terminal that may, or not, be color coded or similar terminal connection.

4. The system of claim 1 further comprising at least a first volume potentiometer arranged along said circuit, whereby said circuit comprised at least one selector switch for selectively connecting at least one of the first and/or second tone potentiometers and/or said third potentiometer to said circuit.

5. The system of claim 1 further comprising at least a second volume potentiometer arranged along said circuit, whereby said circuit comprised at least one selector switch for selectively connecting at least one of the first and/or second tone potentiometers and/or said third potentiometer to said circuit.

6. The system of claim 1 further comprising at least a third volume potentiometer arranged along said circuit, whereby said circuit comprised at least one selector switch for selectively connecting at least one of the first and/or second tone potentiometers and/or said third potentiometer to said circuit.

7. The system of claim 1 further comprising at least a tone potentiometer arranged along said circuit, whereby said circuit comprised at least one selector switch for selectively connecting at least one of the first and/or second tone potentiometers and/or said third potentiometer to said circuit.

8. The system of claim 1 further comprising at least a second tone potentiometer arranged along said circuit, whereby said circuit comprised at least one selector switch for selectively connecting at least one of the first and/or second tone potentiometers and/or said third potentiometer to said circuit.

9. The system of claim 1 whereby said first and said second potentiometer forms a first potentiometer side circuit, and said at least third potentiometer forms a second potentiometer side circuit; and whereby said first side circuit is associated with a first pickup and said second side circuit associated with the second pickup.

10. The system of claim 1 further comprising at least a fifth tone potentiometer arranged along said circuit, whereby said comprises at least one selector switch for selectively connecting at least one of said first and/or second volume potentiometers and/or said third potentiometer and/or said fourth and/or said fifth potentiometer to said circuit.

11. The system of claim 1 further comprising at least one volume potentiometer arranged along said circuit, whereby said comprises at least one output jack.

12. The system of claim 1 further comprising:
a. at least a first volume potentiometer of multiple resistance values with a bushing diameter of 8 millimeters and 12 millimeters in length;
b. at least a second volume potentiometer of multiple resistance values with a bushing diameter of 8 millimeters and 12 millimeters in length;
c. at least a third volume potentiometer of multiple resistance values with a bushing diameter of 8 millimeters and 12 millimeters in length;
d. at least a first tone potentiometer of multiple resistance values with a bushing diameter of 8 millimeters and 12 millimeters in length;
e. at least a second tone potentiometer of multiple resistance values with a bushing diameter of 8 millimeters and 12 millimeters in length;
